(19) United States
(12) Patent Application Publication
(10) Pub. No.: US 2014/0164221 A1
(43) Pub. Date: Jun. 12, 2014

(54) TIME-LIMITED FUND SHARING METHOD AND APPARATUS

(71) Applicants: James Sinton, Leigh-on-Sea (GB); Richard Burdett, Sawbridgeworth (GB); Hemal Sanghvi, St. Charles, MO (US)

(72) Inventors: James Sinton, Leigh-on-Sea (GB); Richard Burdett, Sawbridgeworth (GB); Hemal Sanghvi, St. Charles, MO (US)

(21) Appl. No.: 13/709,355

(22) Filed: Dec. 10, 2012

(51) Int. Cl. G06Q 20/22

(52) U.S. Cl. CPC G06Q 20/22
USPC 705/39

(57) ABSTRACT

A system, method, and computer-readable storage medium configured to enable the pooling and sharing of funds to cover shared expenses for a limited time. An electronic basket is created. The electronic basket includes a virtual prepaid payment card with a unique identifier and associated with a user. The user is prompted for potential contributors to the electronic basket. A network interface electronically contacts the potential contributors, and the electronic basket is stored in a user-card database. When the basket expires, users are prompted to extend the time period, or remaining funds are returned to basket contributors.

### BACKGROUND

1. Field of the Invention

Aspects of the disclosure relate in general to financial services. Aspects include an apparatus, system, method and computer-readable storage medium to enable the pooling and sharing of funds to cover shared expenses.

2. Description of the Related Art

When individuals have shared expenses, a dilemma of funding the shared expenses is created.

In some instances, multiple individuals can pay a single bill by using multiple individual payment cards. For example, when a group of individuals go out to dinner at a restaurant, each person may present a payment card. As this creates an additional burden on the restaurant, many restaurants limit the number of payment cards that can be presented with a bill. Additionally, the fairness of the restaurant scenario is in question when people order entrees of different costs, as restaurants usually evenly divide the bill among payers.

Even worse, many vendors such as department stores, supermarkets, “big box” stores or gas stations will not accept multiple payment cards for a single transaction. In these instances, usually one person receives cash from their cohorts and then pays the vendor directly with the cash or a payment card, such as a prepaid gift card 100 as shown in FIG. 8.

More complex is when multiple individuals are paying for different expenses for a joint project. For example, if a number of people are going on a camping trip, one person may be assigned to buy groceries, another to buy camping gear, and yet another person may have to pay for gas and miscellaneous items. Keeping track of total expenses and evenly funding the enterprise becomes a logistical nightmare.

### SUMMARY

Embodiments include a system, device, method and computer-readable medium to enable the pooling and sharing of funds to cover expenses. An electronic basket is created with an expiry. The electronic basket includes a virtual prepaid payment card with a unique identifier and associated with a user. The user is prompted for potential contributors to the electronic basket. A network interface electronically contacts the potential contributors, and the electronic basket is stored in a user-card database. When the basket expires, users are prompted to extend the time period, or remaining funds are returned to basket contributors.

### BRIEF DESCRIPTION OF THE DRAWINGS

FIG. 1 illustrates an embodiment of a system configured to enable the pooling and sharing of funds to cover expenses.

FIG. 2 depicts an apparatus embodiment configured to enable the pooling and sharing of funds to cover expenses.

FIGS. 3A-3B flowchart a method embodiment to enable the pooling and sharing of funds to cover expenses over a limited time period.

FIG. 4 is a flowchart of an embodiment to enable multiple payers to spend shared funds.

FIG. 5 illustrates a flowchart of an embodiment to enable a payer to spend shared funds and notify contributors of the payment on their behalf.

FIG. 6 depicts a method embodiment to enable a contributor to supplement shared funds.

FIG. 7 illustrates a flowchart of an embodiment to enable return of funds when contributors depart.

FIG. 8 illustrates an example payment card.

### DETAILED DESCRIPTION

One aspect of the disclosure includes the realization that individuals may be able to pool their funds in real-time. Embodiments enable users to dynamically pool and share funds to cover joint expenses. Conceptually, a basket is a virtual payment card or electronic wallet, which can be funded by contributors. The creator of the basket is authorized to make payments using contributed funds within the basket. The basket creator may also nominate and authorize others to make payments with the funds pooled within the basket.

By using a basket, contributors can more fairly allocate expenses. By facilitating multiple payers from a basket, collaborators can more easily share common funds. Moreover, users can make payments to multiple vendors while still keeping track of their shared expenses.

In another aspect of the disclosure, embodiments notify and keep contributors informed on payments made on their behalf with the contributed funds.

These and other benefits may be apparent in hindsight to one of ordinary skill in the art.

Embodiments of the present disclosure include a system, method, and computer-readable storage medium configured to pool and share funds to cover joint expenses.

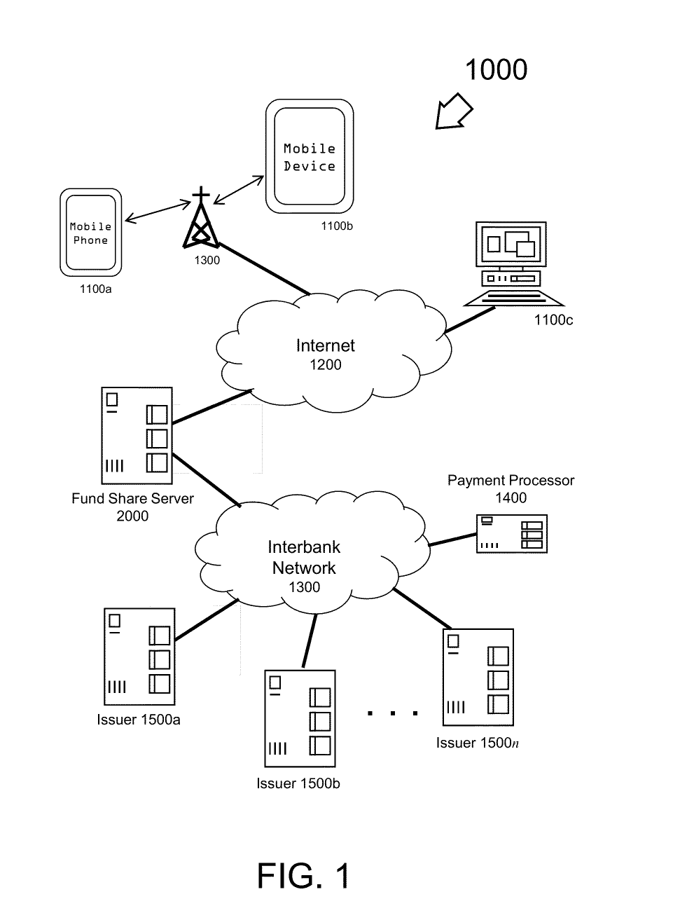

FIG. 1 illustrates an embodiment of a system 1000 configured to enable the pooling and sharing of funds to cover expenses, constructed and operative in accordance with an embodiment of the present disclosure. System 1000 includes consumers using a plurality of computing devices 1100a-c to connect to a fund share server 2000 via a data network 1200, such as the Internet. Details and example uses of fund share server 2000 are discussed below.

In some embodiments, consumers may use a mobile phone 1100a, mobile device 1100b, or personal computer 1100c and connect to fund share server 2000 via a wireless data network 1300 capable of connecting to the Internet. It is understood that wireless data network 1300 may be a wireless data provider such as a cellular telephone network, wireless local area network (WLAN or “WiFi networks”), satellite data networks, and the like. Computing devices 1100 include mobile devices such as mobile telephones, tablet computers, laptop computers, “ultra books” or other portable computing device known in the art capable of communicating to fund share server 2000.

As shown in FIG. 1, fund share server 2000 may be connected to payment processor 1400 and issuers 1500a-n via an interbank network. In some embodiments, fund share server 2000 may be located at payment processor 1400 or at an issuer 1500.

Payment processor 1400 is a payment network capable of processing payments electronically. An example payment processor 1400 includes MasterCard International Incorporated.

Issuers 1500a-n include any banks and other entities that issue payment cards 100.

An interbank network 1300 is a computer network that connects different banking institutions. For example, an Automated Teller Machine (ATM) consortium network is an interbank network.

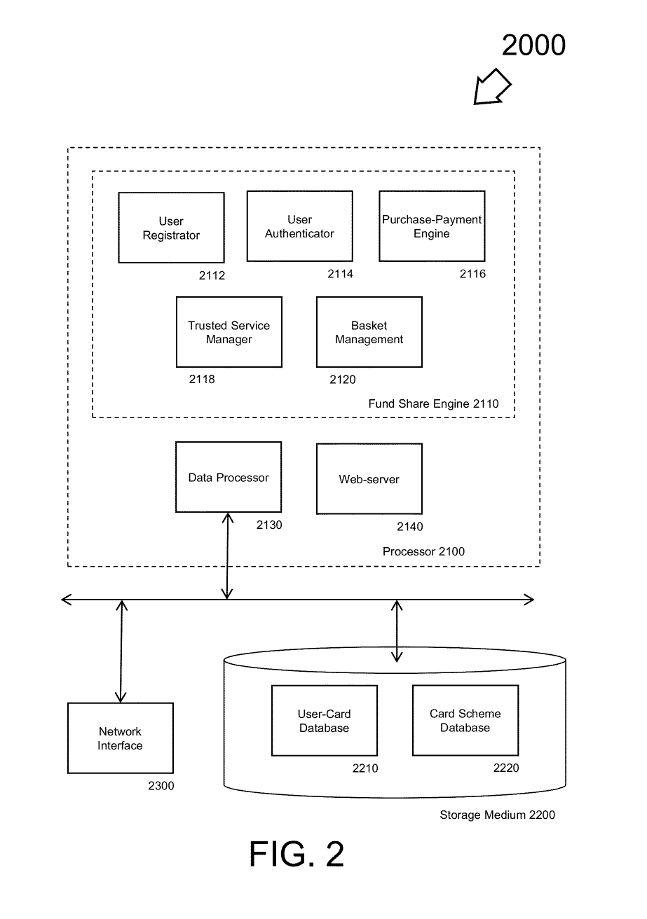

Embodiments will now be disclosed with reference to a block diagram of an exemplary fund share server 2000 of FIG. 2, constructed and operative in accordance with an embodiment of the present disclosure. Fund share server 2000 is configured enable the pooling and sharing of funds to cover expenses.

Fund share server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art.

It is well understood by those in the art, that the elements of FIG. 2 may be implemented as hardware, firmware, or as software instructions and data encoded on a non-transitory computer-readable storage medium 2200.

As shown in FIG. 2, processor 2100 is functionally comprised of a fund share engine 2110, a web-server 2140, and a data processor 2130.

Fund share engine 2110 may further comprise: user registrator 2112, user authenticator 2114, purchase-payment engine 2116, trusted service manager 2118, and basket management 2120. User registrator 2112 enables consumers to register and input their associated payment card information into a user-card database 2210. User authenticator 2114 is an interface that allows users to authenticate themselves with fund share engine 2110. Purchase-payment engine 2116 performs payment and purchase transactions to fund a basket or make payments from a basket. Trusted service manager 2118 provides the fund share engine 2110 secure element provisioning with mobile devices, such as mobile phone 1100a or mobile device 1100b. Basket management 2120 enables the fund share engine 2110 to determine the basket balance, and tracks the contributors to the basket. These structures may be implemented as hardware, firmware, or software encoded on a computer readable medium, such as storage media 2200. Further details of these components are described with their relation to method embodiments below.

In some embodiments, payment-purchase engine 2116 and trusted service manager 2118 may be a service separate from fund share server 2000, and may exist at payment processor 1400 or issuer 1500.

Data processor 2130 interfaces with storage media 2200 and network interface 2300. The data processor 2130 enables processor 2100 to locate data on, read data from, and write data to, these components.

Web-server 2140 is any computing device configured to deliver web pages or other content across the Internet 1200 via network interface 2300; user devices 1100 may communicate with a fund share engine 2110 via the World-Wide-Web protocol and web-server 2140.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows fund share server 2000 to communicate with internet 1200, consumer 1100, consumers using mobile payment devices 1100d-e, interbank network 1300, payment processor 1400, and issuers 1500a-n.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 2200 may be remotely located from processor 2100, and be connected to processor 2100 via a network such as a local area network (LAN), a wide area network (WAN), or the Internet 1200.

In addition, as shown in FIG. 2, storage media 2200 may also contain a user-card database 2210, and a card scheme database 2220. User-card database 2210 is configured to store information associating users with baskets and payment cards. Users may be individuals, businesses, or other entities. For individual user accounts, users may be associated with one or more baskets. Baskets may accept contributions from multiple individual users through the processes described below. Card scheme database 2220 facilitates the look-up of issuers 1500 as described below.

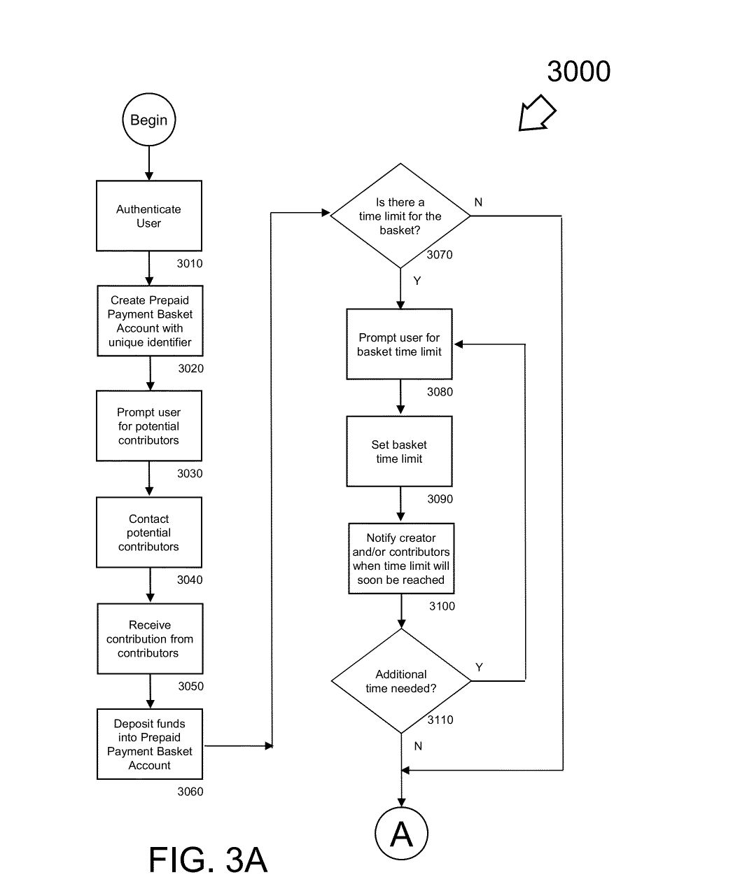

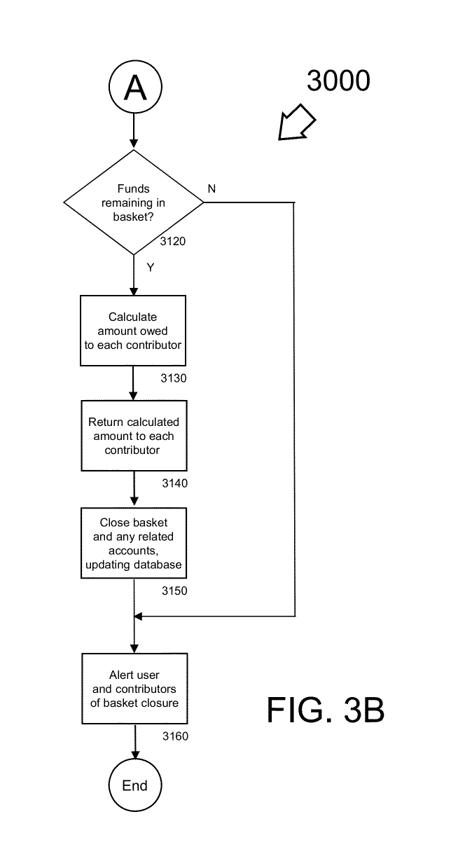

It is understood by those familiar with the art that one or more of these databases 2210-2220 may be combined in a myriad of combinations. The function of these structures may best be understood with respect to the flowcharts of FIGS. 3-7, as described below.

We now turn our attention to method or process embodiments of the present disclosure, FIGS. 3-7. It is understood by those known in the art that instructions for such method embodiments may be stored on their respective computer-readable memory and executed by their respective processors. It is understood by those skilled in the art that other equivalent implementations can exist without departing from the spirit or claims of the invention.

It is further understood that embodiments of the present disclosure may be applied to a variety of payment card types, including credit, debit, charge, prepaid cards and electronic wallets (subject to any applicable financial regulatory restrictions and requirements). An electronic wallet is a program or service where users can store and control their online shopping information, like logins, passwords, shipping address and payment card details, in one central place.

Some embodiments may be restricted to either prepaid cards or debit cards. Other embodiments allow pooling of funds from one type of payment card to another; for example, a cash advance from a credit card may be pooled with funds from a debit card into a basket (subject to any applicable financial regulatory restrictions and requirements). Similarly, in addition to card-based accounts, funding sources may also include any form of electronic payment account, such as a bank account or money market account.

FIGS. 3A-3B flowchart a method 3000 in which an embodiment enables the pooling and sharing of funds to cover expenses over a limited time period through fund share server 2000, constructed and operative in accordance with an embodiment of the present disclosure. Process 3000 may be referred to as basket creation.

At block 3010, user authenticator 2114 receives information from user 1100 to authenticate the user against data stored in the user-card database 2210. Embodiments may authenticate users using any method known in the art including, but not limited to: passwords, cardkeys, optical recognition, fingerprint identification, and facial recognition.

Basket management 2120 creates a prepaid payment basket account with a unique identifier, block 3020. With such a virtual payment card, a card number uniquely identifies a record in a central database at the card issuer, where the balance is recorded. This unique number is commonly referred to as a Primary Account Number (PAN). As part of the basket account creation at block 3020, basket management 2120 associates the created basket with an issuer 1500. The issuer may be predetermined in advance, or in some embodiments, the user may select an issuer 1500 of their choice.

Additionally, basket management 2120 may also generate ancillary information normally associated with a payment card. Such information may vary, but the most common include: Name of virtual card holder, account number, Expiration date, and a security code (such as a Card Verification Value or “CVV” code). In some instances, the ancillary information associated with the account is predetermined and provided by the issuer and then associated with the account number.

In some embodiments, the user may be prompted to name or attach a descriptive label to the basket. For example, a user may decide to name the basket after the intended fund payment activity, such as “Family trip to Vienna” or “Denise's surprise birthday party expenses.” In yet other embodiments, basket management 2120 includes a budgeting apparatus that allows the user to elaborate details on the intended activity. For example, the type of expenses including their currency amounts may be specified for the trip to Vienna: train tickets $100, hotel charges $50, sightseeing expenses $50=total $200.

The basket information is stored at user-card database 2210.

The user is prompted to list contributors for the basket, block 3030. The contributors may be added via a variety of different ways. For example, users may be prompted to add potential contributors via their contacts on the mobile device 1100, via social network contacts, telephone numbers, e-mail addresses or any other electronic identifier known in the art.

At block 3040 fund share engine 2110 contacts all the specified potential contributors requesting their contribution to the basket. If the potential contributor is a known user that has specified a designated contact method in user-card database 2210, fund share engine 2110 contacts the potential contributor via the designated contact method. Contact methods may occur via an application running on mobile device 1100, e-mail, Short Message Service (SMS), text messages, voicemail messages, telephone calls, social networking service, or any other contact method known in the art.

Note that some embodiments skip blocks 3030 and 3040, and may receive contributions to the basket without making the request. In such embodiments, contributors may look up baskets via their “friends” contacts or from the description label attached to the basket.

At block 3050, purchase-payment engine 2116 processes contributions are received from contributors. Contributors may be able to send contributions in a myriad of ways. Contributors can contribute from their debit card accounts, credit card accounts, electronic funds transfer, or any other electronic method known in the art. In certain embodiments, contributions from credit card accounts, the contribution are considered a cash advance. In alternate embodiments, the contribution from certain types of accounts may have transaction fees attached to cover the overhead of the transaction.

Additionally, when contributions are made, the basket management 2120 associates a record of the contribution (along with the amount, contributor, and contributor contact information) with the basket information in user-card database 2210.

Purchase-payment engine 2116 deposits contributions into the basket at block 3060, and process 3000 ends. Contributions may be considered as a deposit made to the balance of a virtual prepaid paid card.

At decision block 3070, the fund share engine 2110 determines whether a time limit is set for the basket. This determination may be made in several different ways. In some embodiments, an automatic expiry time/date is enforced. In yet other embodiments may combine the two. For illustrative purposes only, the embodiment of FIGS. 3A-3B illustrate an embodiment in which the user sets a time limit for the basket.

At block 3080, the basket management 2120 prompts the user for a basket time limit or expiry time. The time limit is set at block 3090, and when the time limit will soon be reached, at block 3100, a warning notification is sent to the basket creator and/or contributors. The warning notification may be sent at a fixed time before basket expiry, such as 15-minutes, or the basket creator may specify a time they want to be informed, for example a day before the basket expires. Some embodiments prompt the basket creator to determine whether additional time is needed, at block 3010. If more time is needed, the process flow returns to block 3080, or otherwise continues to block 3120 on FIG. 3B.

When the time period expires, basket management 2120 determines if funds remain in the basket, block 3120. If no funds remain, the process continues at block 3160.

If funds within the basket remain unspent, as determined at block 3120, the funds are returned to the contributors. At block 3130, basket management 2120 calculates the amount owed to each contributor. Depending upon the implementation, the remaining unspent funds may be divided evenly. For example, if Denise, Karin and James each contributed to the basket, each would receive equal (⅓) share of the remaining funds. It is understood by those in the art that an approximate equal amount may be distributed—i.e., if a dollar remains, Denise may receive $0.34, Karin receives $0.33, and James receives $0.33, as fractional cents are not distributed. Alternatively, funds may be returned on a proportional basis depending upon each contributor's contribution. An example of the latter embodiment would work as follows. If Denise contributed 50% of the original funds, Karin 30%, and James 20%, Denise would receive 50% of the remaining unspent funds, while Karin would receive 30%, and James would each receive 20%. Similarly, an approximate proportional amount may be returned, as fractional cents are not distributed. The calculated amount is returned to each contributor at block 3140. The basket and any related accounts are closed, and the user-card database 2210 is updated accordingly at block 3150.

In some embodiments, a service fee may be deducted from the amount returned to each contributor.

The user and all contributors are notified of the basket closure at block 3160, and the process ends.

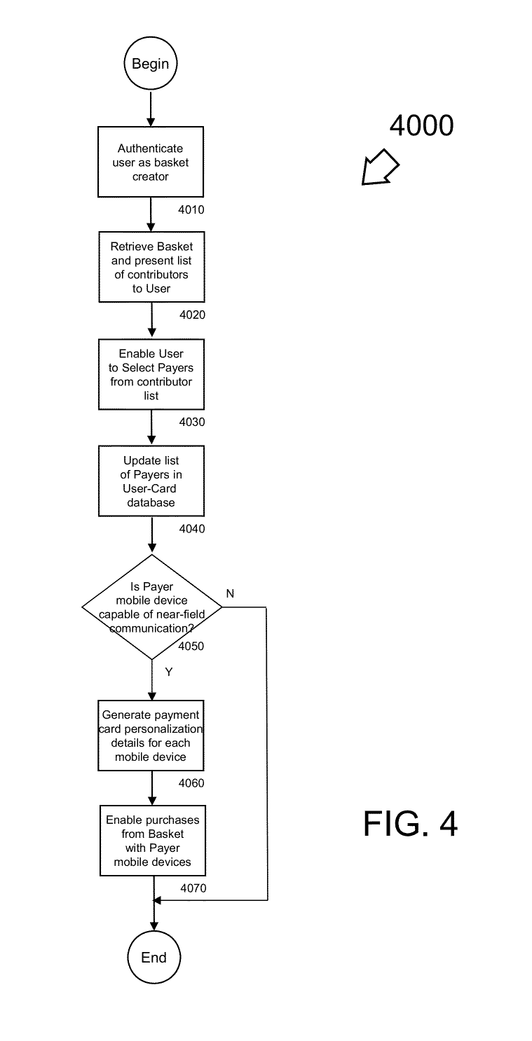

Initially, in the process described above, the user from the basket creation process 3000 defaults to being a person authorized to spend contributed funds from the basket, which will henceforth be referred to as a “payer.” Additionally, it is assumed that contributors are not always authorized to spend the contributed funds. More likely, the default is more likely that contributors are not allowed to spend contributed funds. Moving to FIG. 4, method 4000 enables the basket creator to designate multiple payers to spend shared funds, constructed and operative in accordance with an embodiment of the present disclosure. It is understood by those familiar with the art that in some embodiments, payers are designated by the basket creator from the set of contributors. In other embodiments, payers are not contributors at all, but trusted individuals. In yet another embodiment, some or all contributors are automatically payers.

Furthermore, the embodiment described below supports mobile devices capable of near-field communication (NFC). Near field communication is a set of standards for smartphones and similar devices to establish radio communication with each other by touching them together or bringing them into close proximity.

At block 4010, user authenticator 2114 receives information from basket creator 1100 to authenticate the user against basket data stored in the user-card database 2210. Similar to block 3010 above, embodiments may authenticate users using any method known in the art including, but not limited to: passwords, cardkeys, optical recognition, fingerprint identification, and facial recognition.

The basket management 2120 retrieves the basket information from user-card database 2210, including a contributor list which is presented to the authenticated basket creator, block 4020

Fund share engine 2110 enables the basket creator to select payers from the contributor list, block 4030. In some embodiments, the basket creator may authorize payers from other lists, which include non-contributors.

Once the payers are selected, an updated list of payers associated with the basket is recorded in the user-card database 2210, block 4040. Fund share engine 2110 contacts all the specified potential contributors requesting their contribution to the basket. If the newly authorized payer has specified a contact method in user-card database 2210, fund share engine 2110 alerts the newly authorized payers via their designated contact method. Contact methods may occur via an application running on mobile device 1100, e-mail, Short Message Service (SMS), text messages, voicemail messages, telephone calls, or any other contact method known in the art.

If a payer's mobile device is capable of near-field communication, as determined at block 4050, basket management 2120 generates a payment card personalization details for each mobile device, block 4060. Such personalization details may include a separate PAN for each mobile device, which enables purchases from the basket by the payer mobile device, and subsequent tracking of which payer is making the payment, block 4070.

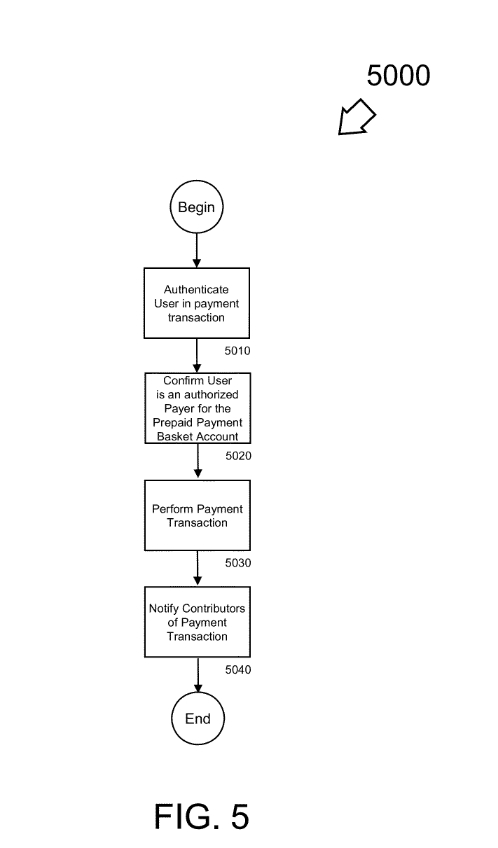

When contributors pool funds for a purpose, they expect that their money is used wisely; process 5000 in FIG. 5 illustrates an embodiment to notify contributors of a payment made on their behalf, constructed and operative in accordance with an embodiment of the present disclosure.

At block 5010, user authenticator 2114 receives information to authenticate the payer against basket data stored in the user-card database 2210. Similar to blocks 3010 and 4010 above, embodiments may authenticate users using any method known in the art including, but not limited to: passwords, cardkeys, optical recognition, fingerprint identification, and facial recognition.

The basket management 2120 confirms that the user is an authorized payer for the basket at block 5020.

The payment transaction is performed by purchase-payment engine 2116 at block 5030.

Once the payment is completed, the contributors associated with the basket are informed about the payment transaction, block 5040. In embodiments where each payer mobile device is assigned their own PAN, the contributor may be notified about which payer made the payment. Fund share engine 2110 alerts the contributors via their designated contact method. Contact methods may occur via an application running on mobile device 1100, e-mail, Short Message Service (SMS), text messages, voicemail messages, telephone calls, or any other contact method known in the art.

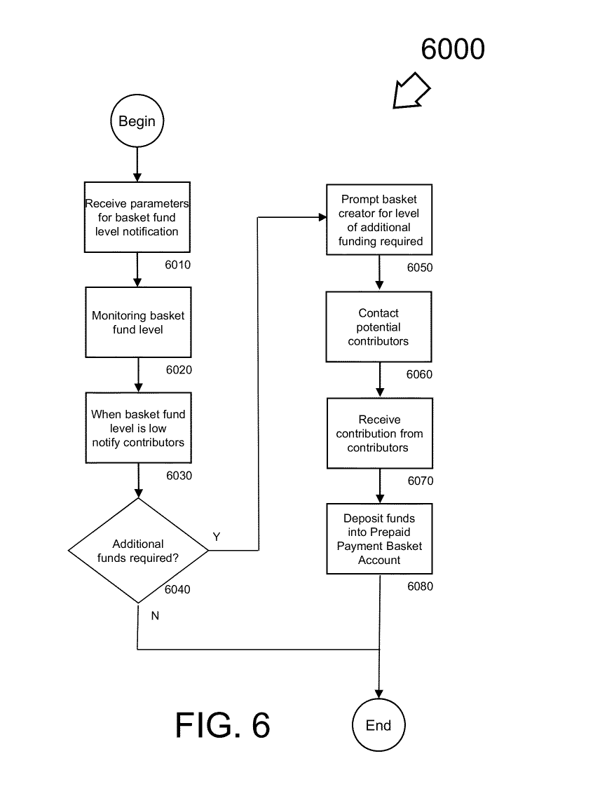

Baskets may be used to pool funds for a variety of different shared activities. Sometimes, when remaining basket funds run low, contributors may be asked to supplement the shared funds. FIG. 6 depicts a method 6000 to enable contributors to supplement shared funds, constructed and operative in accordance with an embodiment of the present disclosure.

In such an embodiment, basket management 2120 may receive parameters for when to notify the creator of diminishing shared basket funds, block 6010. This amount may be set at various levels according to the intended shared activity. The basket creator may specify that an alert be sent when funds reach a specific threshold level. For example, the creator may want an alert when funds fall less than $100. Basket management 2120 would monitor the basket fund level, block 6020, and notify contributors when the basket fund level falls below the $100 threshold, block 6030.

If additional funds are required for the shared activity as determined at decision block 6040, the basket creator is prompted for the level of additional funding required, block 6050.

The contributors are notified of their share of additional funds, block 6060, and once the contribution is received, block 6070, the funds are deposited into the prepaid payment basket account, block 6080. Process 6000 then ends.

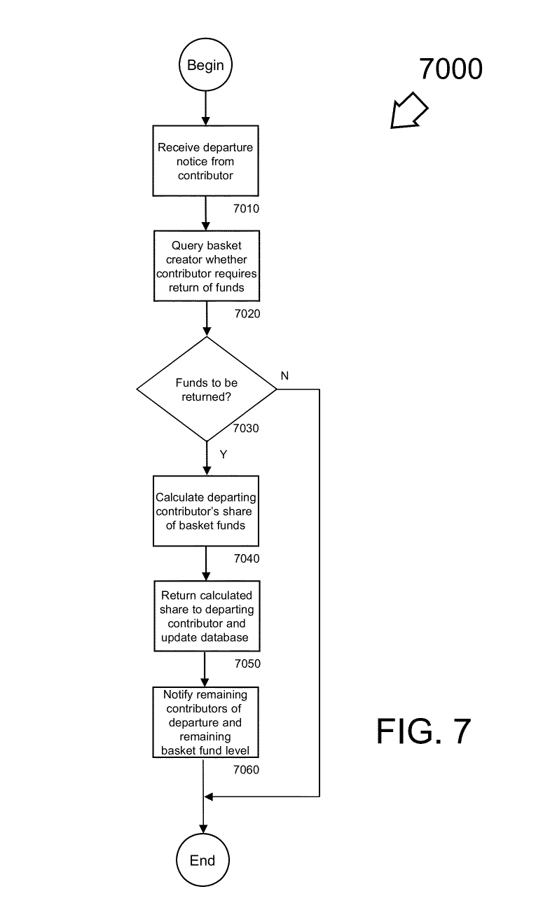

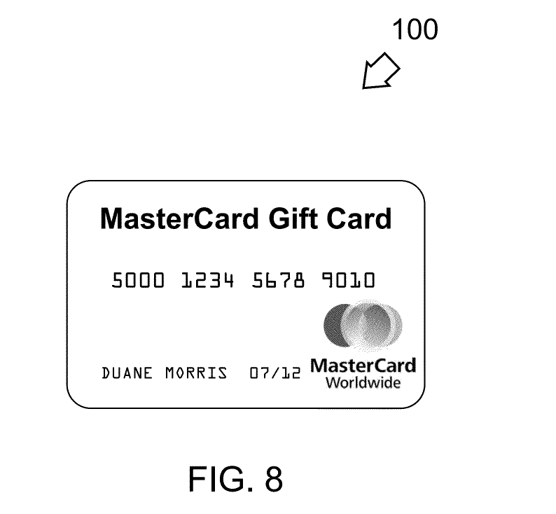

During a shared activity, such as a drinks outing, a basket contributor may decide to depart early. In such instances, the contributors may be refunded their share of the remaining funds. FIG. 7 illustrates a flowchart of a process 7000 to enable return of funds when contributors depart, constructed and operative in accordance with an embodiment of the present disclosure.

In this embodiment, basket management 2120 receives a departure notice from a contributor, block 7010. Basket management 2120 queries the basket creator whether the contributor requires the return of funds, block 7020.

If no funds are to be returned, as determined at block 7030, the process ends.

If funds are to be returned, as determined at block 7030, funds are returned to the departing contributor. At block 7040, basket management 2120 calculates the amount owed to the contributor. Depending upon the implementation, the remaining unspent funds may be divided evenly. Alternatively, funds may be returned on a proportional basis depending upon each contributor's contribution.

The calculated amount is returned to the departing contributor at block 7050, and the user-card database 2210 is updated accordingly. If the departing contributor was also designated as a payer, their payer status is terminated; their related account its associated PAN is closed.

The remaining contributors are notified of the departure, and informed about the remaining basket fund level, block 7060. Process 7000 then ends.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

1. A method comprising:
creating an electronic basket, with a processor, the electronic basket comprising a virtual prepaid payment card with a unique identifier and associated with a user, the electronic basket having an expiry time;
prompting a user for potential contributors to the electronic basket via a network interface;
electronically contacting the potential contributors via the network interface; and,
storing the electronic basket in a user-card database;
wherein unspent remaining funds are returned to contributors when the electronic basket expires.

2. The method of claim 1, further comprising:
electronically receiving a contribution from the potential contributor via the network interface.

3. The method of claim 2, further comprising:
noting the potential contributor has contributed a contribution to the electronic basket in the user-card database.

4. The method of claim 3, further comprising:
depositing funds associated with the contribution from the potential contributor into the electronic basket.

5. The method of claim 4, wherein the user is notified prior to the expiry time.

6. The method of claim 5, wherein a processor calculates an amount to be returned to each of the potential contributors when the electronic basket expires.

7. The method of claim 5, wherein a processor calculates a proportional amount to be returned to each of the potential contributors when the electronic basket expires.

8. The method of claim 5, wherein a processor calculates an approximate equal amount to be returned to each of the potential contributors when the electronic basket expires.

9. The method of claim 5, wherein the user is prompted for the expiry time for the electronic basket.

10. The method of claim 9, wherein the potential contributors are prompted to contribute additional funds to the electronic basket.

11. An apparatus comprising:
a processor configured to create an electronic basket, the electronic basket comprising a virtual prepaid payment card with a unique identifier and associated with a user, the electronic basket having an expiry time, the processor further configured to prompt a user for potential contributors to the electronic basket;
a network interface configured to electronically contact the potential contributors; and
a database configured to store the electronic basket;
wherein unspent remaining funds are returned to contributors when the electronic basket expires.

12. The apparatus of claim 11, wherein the network interface is further configured to receive a contribution from the potential contributor.

13. The apparatus of claim 12, wherein the processor is further configured to note the potential contributor has contributed a contribution to the electronic basket in the database.

14. The apparatus of claim 13, wherein the processor is further configured to deposit funds associated with the contribution from the potential contributor into the electronic basket.

15. The apparatus of claim 14, wherein the user is notified prior to the expiry time.

16. The apparatus of claim 15, wherein the processor calculates an amount to be returned to each of the potential contributors when the electronic basket expires.

17. The apparatus of claim 15, wherein the processor calculates a proportional amount to be returned to each of the potential contributors when the electronic basket expires.

18. The apparatus of claim 15, wherein the processor calculates an approximate equal amount to be returned to each of the potential contributors when the electronic basket expires.

19. The apparatus of claim 15, wherein the user is prompted for the expiry time for the electronic basket.

20. The apparatus of claim 19, wherein the potential contributors are prompted to contribute additional funds to the electronic basket.

21. A non-transitory computer readable medium encoded with data and instructions, when executed by a computing device the instructions causing the computing device to:
create an electronic basket with an expiry time, the electronic basket comprising a virtual prepaid payment card with a unique identifier and associated with a user;
prompt a user for potential contributors to the electronic basket;
electronically contact the potential contributors via a network interface; and, store the electronic basket in a user-card database;
wherein unspent remaining funds are returned to contributors when the electronic basket expires.
